(19) United States
(12) Patent Application Publication
(10) Pub. No.: US 2008/0202705 A1
(43) Pub. Date: Aug. 28, 2008

(54) Cordless Blinds with Secondary Blind Adjustment Means

(75) Inventors: Li-Ming Cheng, Kaohsiung (TW); Kuei-Lin Tsai, Flushing, NY (US)

Correspondence Address: WPAT, PC;INTELLECTUAL PROPERTY ATTORNEYS, 2030 MAIN STREET, SUITE 1300, IRVINE, CA, 92614, US

(73) Assignee: ZIPSHADE INDUSTRIAL (B.V.I.) CORP., Tortola (VG)

(21) Appl. No.: 11/687,608

(22) Filed: Mar. 16, 2007

Related U.S. Application Data
(63) Continuation-in-part of application No. 11/687,590, filed on Mar. 16, 2007.
Application No. 11/687,590 is a continuation-in-part of application No. 11/090,590, filed on Mar. 28, 2005.
Application No. 11/090,590 is a continuation-in-part of application No. 10/743,178, filed on Dec. 23, 2003.
Application No. 10/743,178 is a continuation-in-part of application No. 10/623,776, filed on Jul. 21, 2003, now Pat. No. 6,837,294.
Application No. 10/623,776 is a continuation-in-part of application No. 10/360,305, filed on Feb. 10, 2003, now Pat. No. 6,991,020.

(51) Int. Cl. E06B 9/30; E06B 9/26

(52) U.S. Cl. 160/170; 160/166.1

(57) ABSTRACT

A cordless window covering system with a secondary mechanism to adjust the position of the window covering, to allow manual adjustment of the window covering when the bottom bar is out of reach by hand. In one embodiment, the secondary adjustment system includes a hooked hand tool that engages with a loop in the bottom bar. In another embodiment, the secondary adjustment system includes an exposed beaded corded coupled to the internal mechanisms of the system, so that pulling of beaded cord causes internal mechanisms to move and adjust the position of the window covering.

### CROSS-REFERENCE TO RELATED APPLICATIONS

This application is a continuation-in-part of U.S. patent application Ser. No. 11/687,590, filed on Mar. 16, 2007, no pending, which is a continuation-in-part of U.S. patent application Ser. No. 11/090,590, filed on Mar. 28, 2005, now pending, which is a continuation-in-part of U.S. patent application Ser. No. 10/743,178, filed on Dec. 23, 2003, now pending, which is a continuation-in-part of U.S. Pat. No. 6,837,294, issued on Jan. 4, 2005, and which is a continuation-in-part of U.S. Pat. No. 6,991,020, issued Jan. 31, 2006, all of which are hereby incorporated by reference in their entirety.

Although incorporated by reference in its entirety, no arguments or disclaimers made in the related applications apply to this application. Any disclaimer that may have occurred during the prosecution of the above-referenced application(s) is hereby expressly rescinded. Consequently, the Patent Office is asked to review the new set of claims in view of all of the prior art of record and any search that the Office deems appropriate.

### FIELD OF THE INVENTION

The field of the invention is window coverings, more particularly to method and apparatus for manually adjust window coverage in cordless window shades/blinds/shutters.

### BACKGROUND OF THE INVENTION

Cordless Venetian blinds are known to eliminate incidents of child strangulation caused by hanging pull cords.

However, when cordless blinds are installed to cover tall windows, typical users may have trouble lifting the bottom bar of the blind all the way to the top. Likewise, typical users may have trouble reaching the bottom bar of the blind when it is previously lifted to the highest position possible, perhaps by someone with a ladder.

Thus, there is a need for methods and designs to raise and lower such blinds that are installed in tall windows.

All referenced patents, applications and literatures are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

The invention may seek to satisfy one or more of the above-mentioned desire. Although the present invention may obviate one or more of the above-mentioned desires, it should be understood that some aspects of the invention might not necessarily obviate them.

### SUMMARY OF THE INVENTION

The present invention provides apparatus, systems and methods in which a window covering system utilizing a spring-driven motor has an optional manual pull cord sized and dimensioned so that a user can raise and lower the blinds using the optional pull cord when the bottom of the cordless blind is out of reach by hand. In another aspect of the invention the window covering system has a hand tool so that a user can use the hand tool to raise or lower the blinds when the bottom of the blind is out of reach by hand.

In preferred embodiments, the window blind assembly includes a top housing, a bottom bar, blind or shade, lifting cords, and spring-driven motor. The system may optionally include pulley rotors within the housing to entrain the lifting cords. In other preferred embodiments, the housing may include rotors that are interconnected by gears. Yet in other embodiments, the spring-driven motor may be replaced with an electric motor.

Among the many different possibilities contemplated, the pull cord extends from inside of the housing to exterior of the housing, and is a beaded cord that engages with part of the spring-driven motor so that pulling of the pull cord causes the spring-driven motor to wind or unwind cords, which in turn raises or lower binds.

As for using a hand tool to raise or lower the blinds when the blind is out of reach by hand, it is contemplated that the bottom bar has a receiving surface capable of receiving the hand tool so that a user may use the hand tool to grasp the bottom bar. Contemplated hand tool has a elongated stem, with a tip that may be a loop, a notch, a hook, a groove, an indentation, a projection, or a plurality of grasping fingers. It is further contemplated the hand tool may have movable grasping fingers to grasp the bottom bar of the blind system.

Among the many possible receiving surface types on the bottom bar, it is preferred that the receiving surface is a loop.

Contemplated window blind assembly can cover any size or shape of windows, and can include any suitable material or combination of materials.

Another aspect of the invention is directed to a method of marketing a cordless window covering system by providing a window covering system that can be manually adjusted by direct manual manipulation of the bottom bar, and also provide a secondary device to lower and raise the bottom bar. In one preferred method, the window covering system is marketed as having an optional pull cord that can be removed if not needed. The preferred method provides instruction that the bottom bar may be lowered and raised by pulling on the pull cord. In another preferred method, the window covering system is marketed as having an accompanying hand tool to make engaging contact with the bottom bar, and in turn lower or raise the bottom bar.

Various objects, features, aspects and advantages of the present invention will become more apparent from the following detailed description of preferred embodiments of the invention, along with the accompanying drawing figures in which like numerals represent like components.

### BRIEF DESCRIPTION OF THE DRAWING

FIG. 1 is a frontal view of a first embodiment according to an aspect of the inventive subject matter.

FIG. 2 is a frontal view of another embodiment according to an aspect of the inventive subject matter.

FIG. 3 is a frontal view of the embodiment in FIG. 2 in a slightly raised position.

FIG. 4 is a frontal view of the embodiment in FIG. 2 showing removability of the pull cord.

FIG. 5 is a break-away view of another embodiment according to an aspect of the inventive subject matter.

FIG. 6 is a break away view of the spring-driven motor according an aspect of the inventive subject matter.

FIG. 6A is a break away view of the spring-driven motor according an aspect of the inventive subject matter.

FIG. 6B is a break away view of the spring-driven motor according an aspect of the inventive subject matter.

FIG. 7 is a top view of the spring-driven motor region according an aspect of the inventive subject matter.

FIG. 8 is a break-away view of another embodiment according to an aspect of the inventive subject matter.

FIG. 9 is a perspective view of the inner components of another embodiment according to an aspect of the inventive subject matter.

### DETAILED DESCRIPTION

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Thus, the detailed description set forth below in connection with the appended drawings is intended as a description of the presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions may be accomplished by different embodiments that the spirit of the invention also intends to encompass.

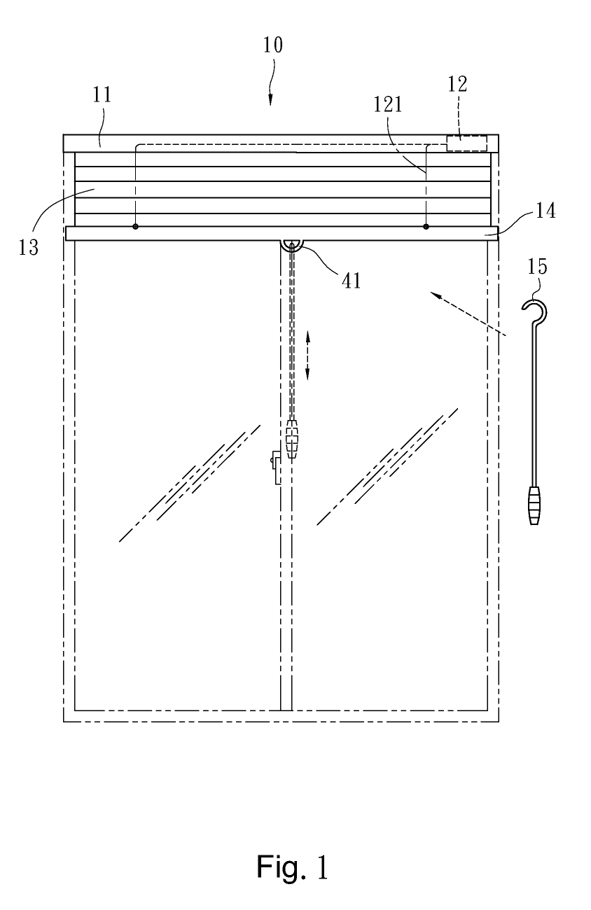

Referring now to FIG. 1, a cordless blind assembly 10 generally has a top elongated housing 11, a window covering 13 such as a blind, shutter, or shade (including Roman shade, cellular shade), and a bottom elongated member 14. Here, the bottom elongated member has a half-loop 41 that receives the hook of a tool 15. The tool 15 can be freely detached from the cordless blind assembly 10 when not in use. A user can raise the bottom elongated member 14 to positions higher than he can normally reach by hand, by first engage the hook into the half-loop 41, and then push the elongated bottom member upward. Likewise, when a user wants to lower the bottom elongated member, the user can use the tool 15 to hook onto the half-loop 41, and then pull on the tool 15 to lower the bottom elongated member 14. The tool 15 has a handle, and a stem is sufficiently long so that a user may reach the bottom elongated member with the tool 15 when the bottom elongated member is closest to the housing.

The half-loop 41 can be made of any suitable material and can be made an integral part of bottom elongated member 14. Alternatively, half-loop 41 can be separately manufactured and subsequently attached to the elongated bottom member 14. As such, the half-loop 41 can also be fastened onto the bottom elongated member 14 by known fasteners such as nails, screws, buttons, or glues. To accommodate consumers who do not want to use the half-loop 41, half-loop 41 can be fastened by detachable means to allow consumer removal. For example, the half-loop 41 can be detachably coupled to the bottom elongated member by snap-on connectors, click-on connectors, buttons, Velcro™ fasteners.

While FIG. 1 shows a half-loop 41 as half-circular opening to receive the hook of a tool 15, the bottom elongated member 14 may implement other types of receiving catch configured to receive a distal end of a tool to achieve the same purpose. For example, the catch can be an aperture formed in the wall of the bottom elongated member, a notch, a hook, a groove, a full loop, an indentation, or a projection. The catch can be made of any suitable material to enable secured engagement with a hand tool 15. The hand tool 15 generally has a elongated stem, and a distal end that can have configurations other than a hook, for example, a loop, a notch, a hook, a groove, an indentation, a projection, a plurality of grasping fingers, a plurality of user-controlled movable fingers. As such, some of all of these examples can also allow the hand tool 15 to grasp any bottom elongated member 14, whether or not there is a receiving catch. In addition, the hand tool 15 can have an extendable stem, such as having telescopic stem.

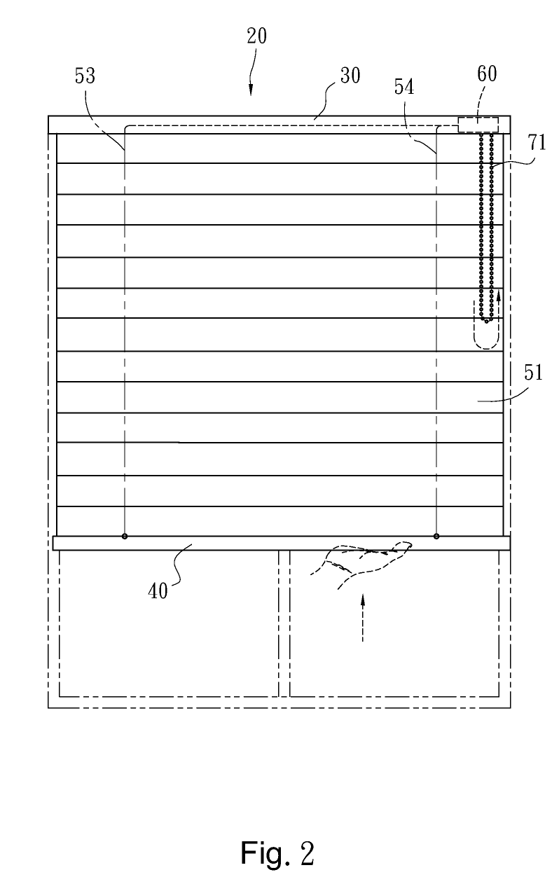

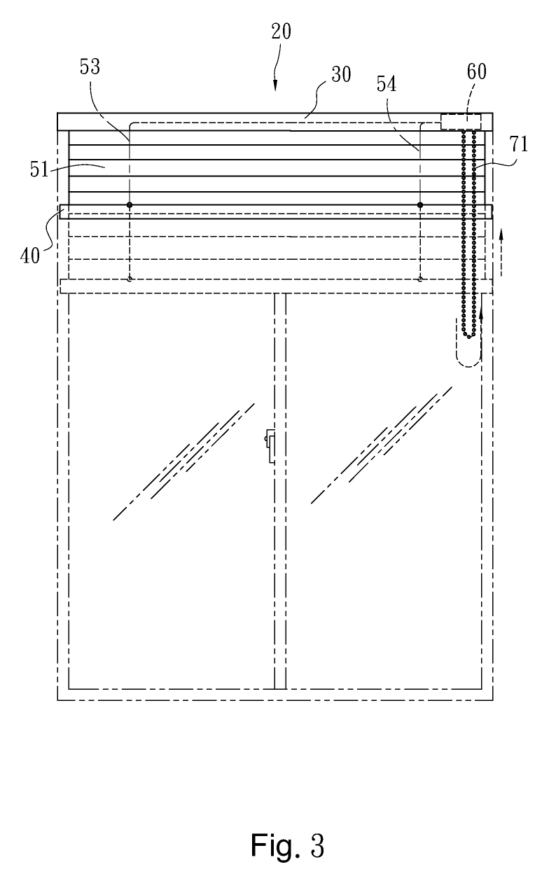

In FIGS. 2-4, blind system 20 has a top housing 30 coupled to window covering 51, bottom elongated member 40 coupled to two lifting cords 53, 54, a spring-driven motor 60 disposed within the top housing 30. Here, a beaded cord 71 is coupled to the spring-driven motor 60, and a major portion of the beaded cord 71 is exposed outside of the top housing 30. A small portion of the beaded cord 71 remains engaged with the spring-driven motor in the interior of the top housing 30, and the beaded cord 71 extends to the outside via an opening in the top housing 30. A user can lower or raise the bottom elongated member 40 by directly pulling or pushing the bottom elongated member 40 by hand. The optional beaded cord 71 allows a user to lower and raise the bottom elongated member 40 when the bottom elongated member 40 is located higher than he can reach by hand.

In operation, a user simply pulls on one strand of the beaded cord 71, the other strand correspondingly moves in the opposite direction. As a result, spring-driven motor inside the top housing 30 is moved to wind or unwind thus causing lifting cords 53, 54 to move. Details of the interaction between the beaded cord 71 and the spring-driven motor 60 will be discussed in further detail below.

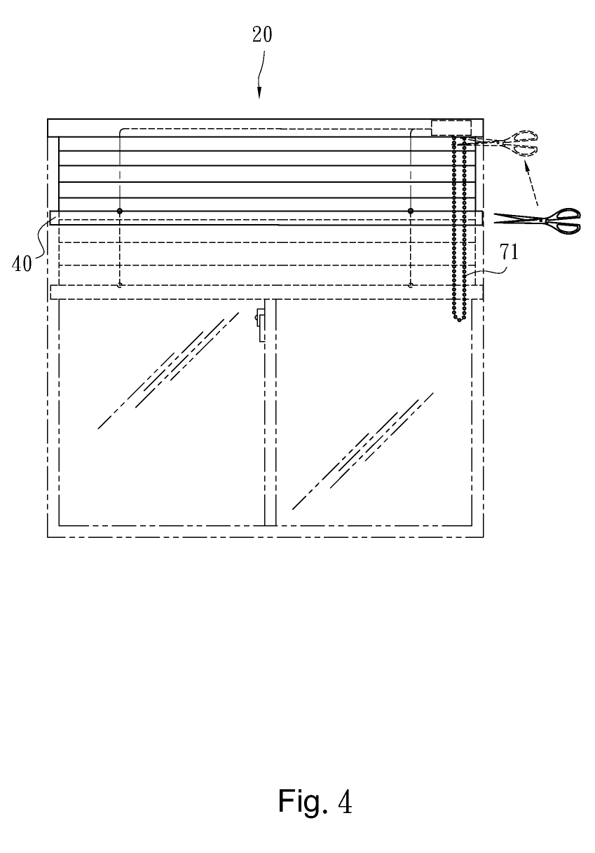

In FIG. 4, a pair of scissors is shown to illustrate that the beaded cord 71 can be completely cut off and removed from the blind assembly, if a user, for aesthetic or safety reasons, does not wish to use it. Removal of the beaded cord 71 does not affect operation of the blind assembly 20. It should be appreciated that although beaded cord 71 is shown is a loop formation, where both ends of the beaded cord 71 are joined, an open loop formation is also possible. In other words, the beaded cord 71 can be of sufficient length so that its two terminal ends do not join together, and are hung freely. This open loop formation can minimize the danger of child strangulation.

In addition, to minimize danger associated with having a looped beaded cord 71, beaded cord 71 have a preferred hanging length no longer than approximately 75% of the maximum hanging length of the blinds, or more preferably, no longer than approximately 50% of the maximum hanging length of the blinds, or even more preferably, no longer than approximately 30% of the maximum hanging length of the blinds, or most preferably, no longer than approximately 25% of the maximum hanging length of the blinds. In this context, the hanging length of the beaded cord 71 refers to the length of the loop of beaded cord as shown in FIGS. 2-4 from the opening where the beaded cord 71 exits, to the lowest point of the beaded cord 71 when the beaded cord 71 naturally hangs from the window assembly. As for the maximum hanging length of the blinds, this refers to the length from the top housing 30 to the lowest most position the bottom elongated member 40 is mechanically permitted to reach under normal operation of the blind assembly, when the blind 51 and bottom elongated member 40 naturally hangs from the top housing 30.

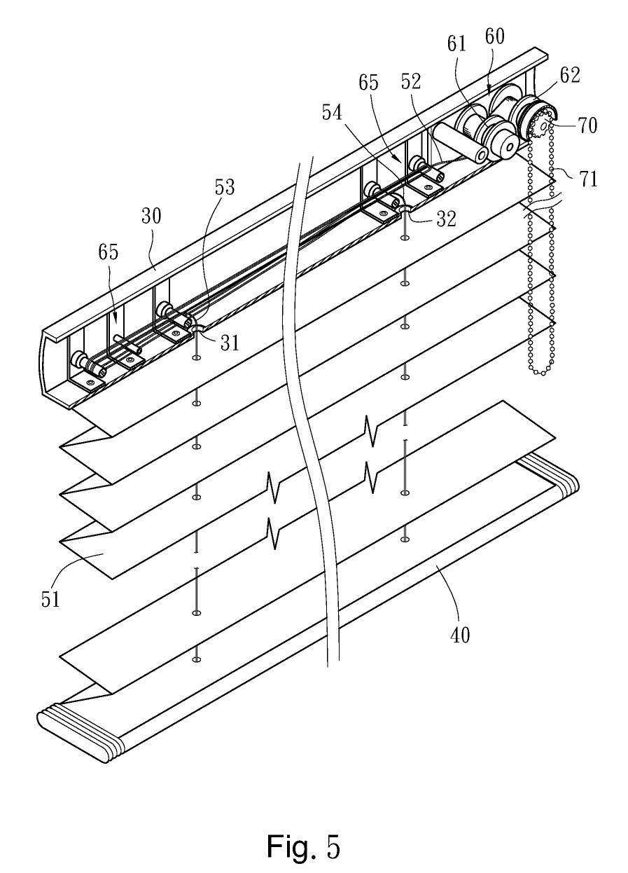

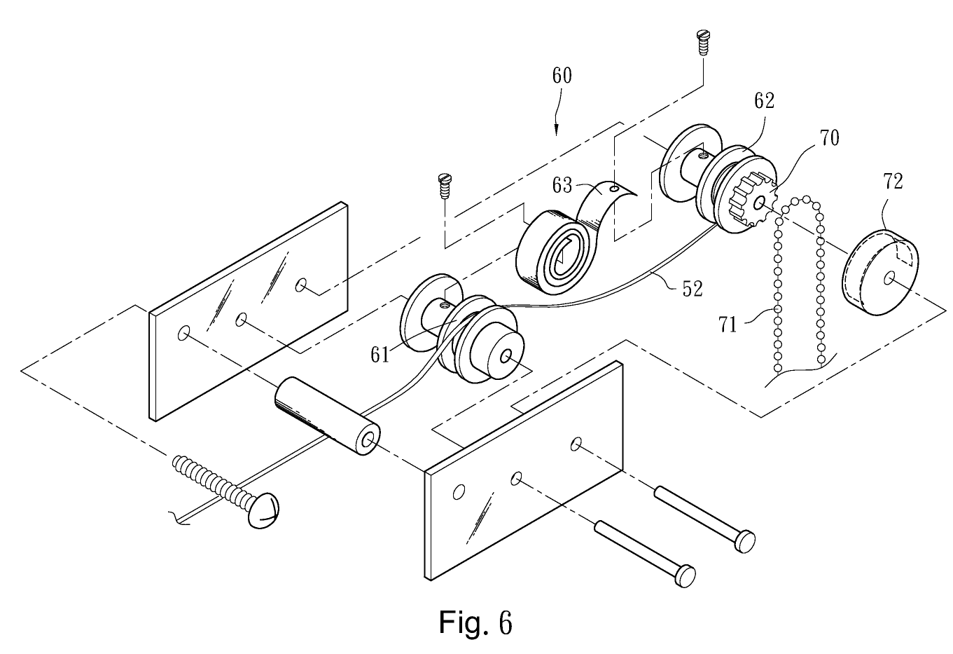

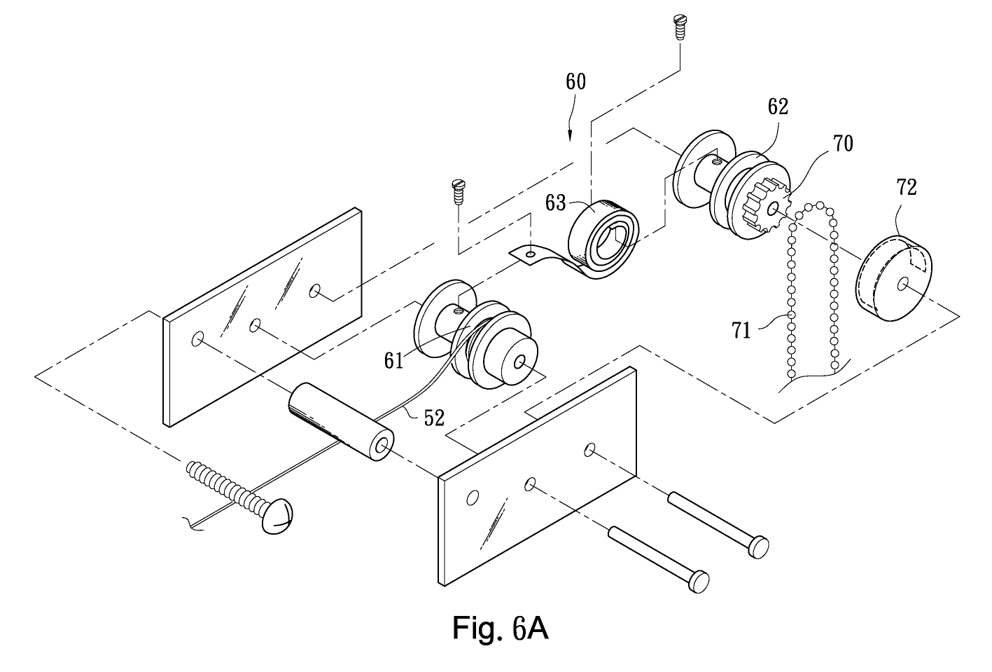

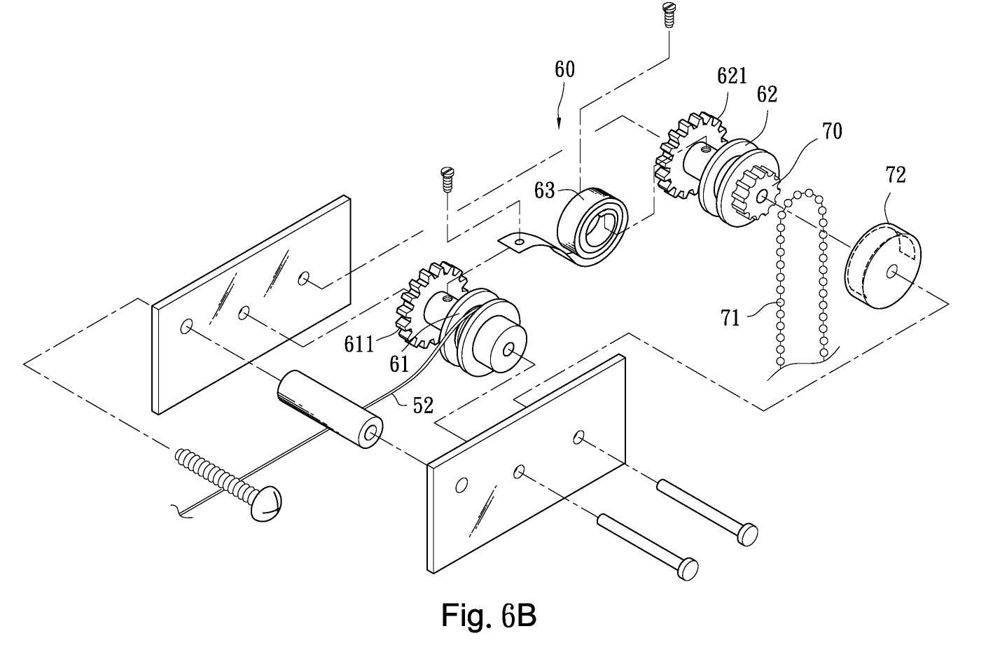

FIGS. 5 and 6 illustrate the inner components of the blind assembly 20 in greater detail. As mentioned earlier, a spring-driven motor 60 is disposed at a terminal end inside the top housing 30. The spring-driven motor has a storage drum 61 and an output drum 62, coupled together by a flat spring 63. The flat spring 63 is attached to the storage drum 61 and the output drum 62 so as to drive the output drum in a direction to wind connecting cord 52. Connecting cord 52 is coupled to the two lifting cords 53, 54. The spring-driven motor 60 provides sufficient counterbalancing force to suspending the bottom elongated member 40 in many vertically adjustable positions. Output drum 62 has an extended wheel 70 with teethed, or gear like surface to receive beads from the beaded cord 71. Wheel 70 is preferably made integral with output drum 62, and does not rotate independently of output drum 62. As such, when beaded cord 71 is in frictional engagement with wheel 70, a user can pull the beaded cord 71 and cause the output drum 62 to turn.

It is also contemplated that the wheel 70 can be replaced with a receiving structure having corresponding receiving surfaces to releasably receive beads of the beaded cord 71. Of course, the receiving structure can also have corresponding receiving surfaces for any other appropriate cords so long as a friction engagement is created such that pulling of the pull cord rotates the receiving structure. For this purpose, the pull cord can have a textured surface, a plurality of protuberances, a plurality of sphere, beads, other irregularly shaped objects. Optionally, the pull cord can be attached to the receiving structure at one end, and partially winds around the receiving structure.

A guard 72 substantially covers over wheel 70, preventing beaded cord 71 from slipping away from frictional engagement with the wheel 70. The guard 72 also prevents other components parts from interfering with the operation of the wheel 70.

Preferred flat spring 63 of motor 60 can have consistent width, or consistent thickness, or both. One skilled in the art can immediately appreciate that different thickness, width, can contribute to the resilient strength of the spring, and can be modified to accommodate different applications of the spring-driven motor. Moreover, other preferred embodiments can implement other spring types or like resilient member of appropriate size and material to drive output drum in a cord-winding direction. Such other resilient member includes: coil spring, leaf spring, compression spring, tension spring, torsion spring, or any other elastic member which exerts a resisting force when its shape is changed. One skilled in the art would appreciate the possibility to implement any capable types of resilient members to drive an output drum. It should be noted, that some embodiments of the invention may implement a resilient member to drive an output drum, without the need for a storage drum.

In another preferred embodiment, the window covering system can use an electric motor instead of a mechanic motor such as one driven by a spring. Although an electric motor would increase manufacturing cost, the electric motor can coupled to a wired or wireless controller, allowing convenience when the window covering system is installed in hard to reach high places. The pull cord as described herein can be coupled to the motor, so that a user can manually adjust the height of the blinds even when the electricity is out.

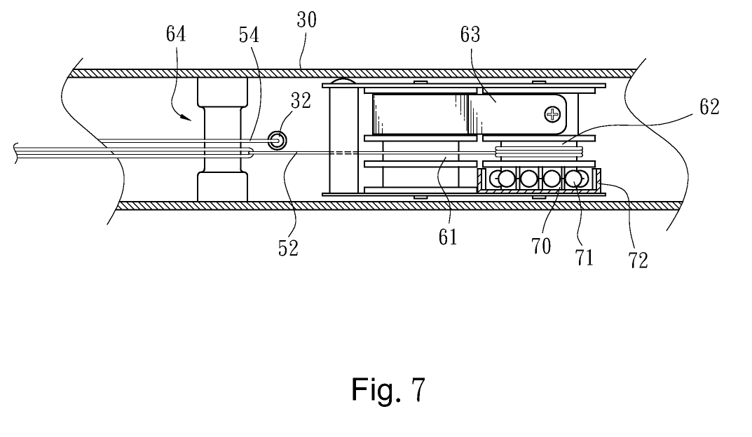

In FIGS. 6, 7, connecting cord 52 is attached to output drum 62 at an end of the connecting cord 52, and the output drum 62 winds and unwinds the connecting cord 52. Connecting cord 52 is also shown to entrain partially over storage drum 61. In other words, storage drum 61 bends the otherwise linear path of connecting cord 52, to increase tension of connecting cord 52. This partial entrainment provides added stability and precision in blind height adjustment. In other embodiments, the connecting cord 52 do not engage in contact with the storage drum. In FIG. 6, the storage drum 61 is shown as positioned in between the output drum 62 and the center of the housing channel. Other contemplated embodiments can have other arrangements, such positioning the output drum to the left of the storage drum (when looking at FIG. 6), or to the top of the storage drum, or under the storage drum, or side-by-side next to the storage drum 61.

FIG. 6A illustrates a variation of the embodiment shown in FIG. 6. Here in FIG. 6A, the spring 63 is positioned in opposite direction when compared with FIG. 6, thus make part number 61 of FIG. 6A the output drum, and part 62 of FIG. 6A the storage drum. One of the major difference FIG. 6A shows is that the pull cord/wheel combination is attached to the storage drum instead of the output drum. In operation, downward pulling of the left portion of the pull cord 71 (causing counter-clockwise turning of the wheel 70) will tend to wind spring 63 onto the storage drum, thus rotate output drum to wind connecting cord 52 and raise the window blind. This embodiment in FIG. 6A, however, does not allow proper transferring of spring 63 from the storage drum (part 62 here) to the output drum (part 61 here), because clockwise rotation of the wheel 70 may not generate sufficient force to biase spring 63 to wind onto the output drum. This embodiment is at the very least capable of using the pull cord 71 to raise the window blind.

FIG. 6B illustrates a variation of the embodiment shown in FIG. 6A. Here in FIG. 6B, output drum and storage drum both have meshing geared teeth such that rotation of one causes the other to rotate as well. As such, pulling of the pull cord 71 in any direction will cause both drums to rotate correspondingly, and the spring 63 will transfer between both drum correspondingly.

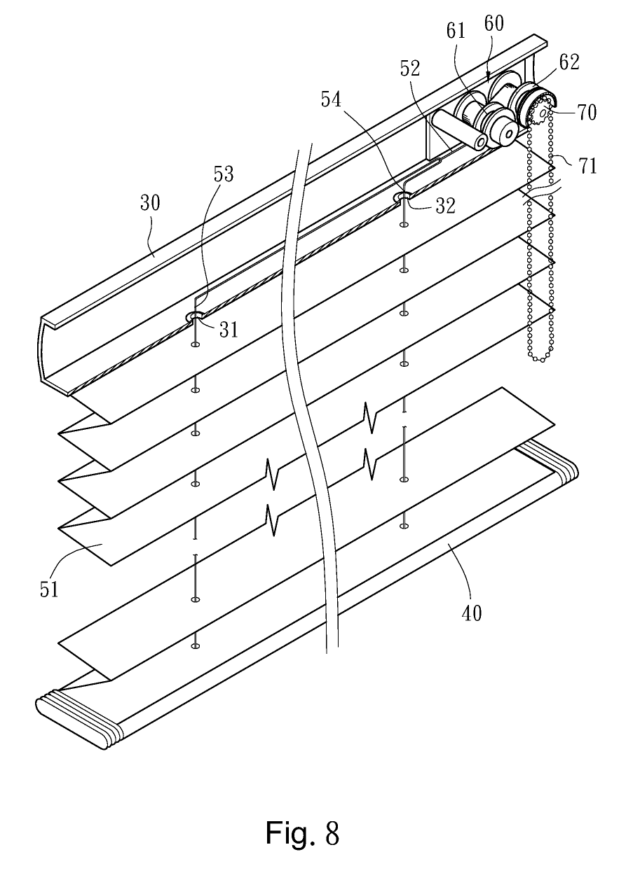

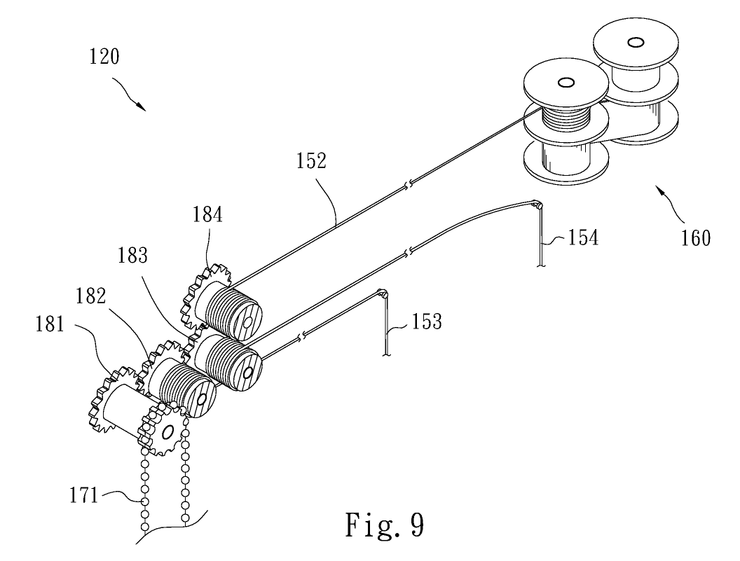

Contemplated embodiments can have an optional rotor set in the channel. This rotor set can be in the form of a pulley system to supplement counter-balancing force of the motor (as shown in FIG. 5, for example), or alternatively be in the form a geared rotors which also supplement counter-balancing force of the motor via specifically designed friction resistance in the gears (as shown in FIG. 9, for example). Other contemplated embodiment can include both a pulley system of FIG. 5 and geared rotors of FIG. 9, where a pulley system can be provided to entrain the connecting cord or lifting cord, or both (not shown). In FIG. 5, optional pulley system has rotors 65 inside the top elongated housing 30 entraining the lifting cords 53, 54. Entrainment of the lifting cords and connecting cords around the pulley system and the drums can be done in ways as previous described in U.S. published patent application US2004/0154758, all of which is hereby incorporated by reference. Alternatively, some embodiments of the current invention do not implement such pulley system, such as the embodiment as shown in FIG. 8.

Turning now to FIG. 9, beaded cord 171 can have other suitable engagement configuration with other component parts of blind assembly 120. Instead of direct engagement with a wheel of the output drum as previously discussed, here, beaded cord 171 is in direct engagement with a wheel of the geared rotor 181. Geared rotors 181, 182, 183, 184 are coupled together with meshing gear teeth. A user pulls beaded cord 171 and turns geared rotor 181, which causes geared rotors 182, 183, and 184 to turn correspondingly. One skilled in the art will immediately appreciate that the wheel structure can instead be provided on any of the other geared rotors 182, 183, and 184. Since geared rotors 182 and 183 store a portion of lifting cords 153, 154, pulling the beaded cord 171 causes geared rotors 182, 183 to wind or unwind lifting cords 153, 154, respectively. Therefore, winding or unwinding of the lifting cords 153, 154 in turn moves the bottom elongated member up and down. The idea is to provide a structure coupled to a pull cord, and the structure mechanically affects movement of the lifting cords/connecting cords.

Here in FIG. 9, connecting cord 152 and lifting cord 153 do not physically touch each other. They are, however, coupled through geared rotors 183 and 184. In other embodiments such as those illustrated by FIGS. 5, 7 and 8, the connecting cord 52 physically connects with lifting cords 53, 54. In such embodiments where the connecting cord and lifting cords physically join together, they can be joined by a knot, a connector, or an adhesive. Also, the connecting cord and the lifting cord can be integrally joined together such that they can be consider a single cord that splits into two lifting ends. Alternatively, the combination of connecting cord and lifting cords can be made from a single cord split into more than one lifting ends. Also, in embodiments where a single connecting cord is used, this single connecting cord can be further strengthened by adding one or more connecting cords to the single connecting cord. One skilled in the art will immediately recognize that using more then one connecting cord to strengthen a single connecting cord is an obvious improvement.

The beaded cord 71 has a cord that can be made of suitable material such as natural or synthetic fiber, with plastic beads equal-distantly disposed along the cord. While beaded cord 71 is used throughout the above discussion, it should be appreciated that other suitable cords are also possible. For example, cords with indentation or texture surface can be used to frictionally engage the wheel, which can have grooves or surface texture to improve frictional engagement with the pull cord. Alternatively, all possible types and shapes of metal ball-chain such as those available from Ball Chain Manufacturing Co. Inc. of New York (www. ballchain.com) can also be used.

It should be noted that it is specifically contemplated that when implementing geared rotors as described herein and in referenced applications, the gears in the geared rotors can have various different circumferences to suit specific ratio of connecting cord travel speed vs. lifting cord speed. For example, rotor 184 of FIG. 9 can have larger circumference than that of rotors 182 and 183 such that connecting cord will travel faster then lifting cord during operation. Another example can be found where circumference of rotor 181 in FIG. 9 is larger than that of rotors 182, 183. This variation provides a different user feel when manually pulling the pull cord 171. One skilled in the art would also recognize that circumference of the wheel can be varied to provide a different user feel when manually pulling the pull cord.

Although the term “blind” is predominantly used above, one of ordinary skill in the art would immediately recognize that shades, shutters may be used interchangeably.

Another aspect of the current invention is a method of marketing a window covering system, by providing any of the embodiments as described above and as described in the referenced patents and applications, and optionally provide a hand tool having a handle, a stem, and a distal end capable of manipulating the bottom elongated member. Optionally, the method includes further providing a written or unwritten instruction describing that the position of the bottom elongated member of a cordless blind can be adjusted by using a secondary mechanism such as a hand tool or a manual pull cord as described above.

Thus, specific embodiments and applications of Manually Adjustable Spring-Driven Window Covering System have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

What is claimed is:

1. A window covering system comprising:
a window covering member providing an area of window coverage;
at least one lifting cord coupled to the window covering member;
at least one connecting cord;
a motor capable of storing and winding a portion of one of the at least one connecting cord;
a elongated housing coupled to the window covering member, the elongated housing enclosing the motor;
a pull cord releasably coupled to a receiving structure, wherein manual pulling of the cord by a user causes the receiving structure to move; and
wherein the receiving structure is coupled to the motor such that movement of the receiving structure also causes the motor to either wind or unwind the at least one connecting cord, which in turn changes the area of window coverage provided by the window covering member.

2. The window covering system of claim 1, wherein the window covering member is selected from the group consisting of window shade, shutter, and window blind, and wherein the window covering member contributes to a suspension weight, and wherein the motor comprises a resilient member to provide counter-balancing force to substantially counter-balance the suspension weight.

3. The window covering system of claim 2, wherein the resilient member is a spring, and wherein the motor further comprises an output drum coupled to at least one spring, and the at least one spring biases the output drum to rotate in a cord-winding rotary direction.

4. The window covering system of claim 3, wherein the receiving structure comprises of a wheel, wherein the wheel frictionally receives a portion of the pull cord such that manual pulling of the pull cord causes the wheel to turn, wherein the wheel is coupled to the output drum, and wherein the pull cord comprises of a textured surface.

5. The window covering system of claim 4, wherein the textured surface is a plurality of protuberances disposed along a length of the pull cord, and wherein the wheel have indentations that releasably receive some of the protuberances of the pull cord.

6. The window covering system of claim 5 further comprising a storage drum coupled to the at least one spring, wherein the connecting cord is at least partially entrained by the storage drum and wound on the output drum, and wherein the pull cord comprises at least one selected from the group consisting of a ball-chain and beaded cord.

7. The window covering system of claim 5, wherein the connecting cord is entrain by the storage drum and wound on the output drum in a FIG. 8 configuration.

8. The window covering system of claim 5 further comprising a pulley set having at least one rotor to entrain the at least one lifting cord.

9. The window covering system of claim 5 further comprising a bottom elongated member coupled to the window covering member, the bottom elongated member having a receiving catch capable of receiving a distal end of a hand tool so that the user can engage the hand tool to the bottom elongated member to raise or lower the bottom elongated member, and wherein the hand tool has a elongated stem, and the distal end of the hand tool has a configuration selected from the group consisting of a loop, a notch, a hook, a groove, an indentation, a projection, a plurality of grasping fingers.

10. The window covering system of claim 9, wherein the catch is a loop, and wherein the pull cord has two ends coupled such a continuous loop is formed.

11. The window covering system of claim 9, wherein the catch is selected from the group consisting an aperture in the bottom elongated member, a notch, a hook, a groove, an indentation, and a projection.

12. The window covering system of claim 3 further comprising at least two rotors mechanically coupled to each other, wherein at least one of the rotors winds and stores a portion of the at least one lifting cord, and wherein at least one of the rotors winds and stores a portion of the at least one connecting cord, and wherein the receiving structure frictionally receives a portion of the pull cord and is coupled to the motor via direct attachment to at least one of the rotors, such that manual pulling of the pull cord causes the receiving structure to turn, which in turn causes at least one rotor to turn, and which in turn causes the motor to either wind or unwind the connecting cord.

13. The window covering system of claim 12, wherein at least two of the rotors have gears and are coupled to each other via meshing gear teeth such that turning of one rotor causes at least one other rotor to turn correspondingly, which in turn causes the output drum to turn via the connecting cord.

14. The window covering system of claim 1, wherein the motor is an electric motor, wherein the receiving structure comprises of a wheel, wherein the wheel receives a pull cord such that manual pulling of the pull cord causes the wheel to turn, and wherein the pull cord comprises at least one selected from the group consisting of a ball-chain and beaded cord.

15. A window covering system comprising:
a window covering member selected from the group consisting of window shade, shutter, and window blind;
a top elongated housing having a channel;
a bottom elongated member coupled to the window covering member and has a receiving catch capable of engaging a distal end of a hand tool so that a user may use the hand tool to adjust position of the bottom elongated member relative to the top elongated housing;
at least one lifting cord coupled to the bottom elongated member; and
a counter-balancing motor disposed in the channel and driven by at least one resilient member.

16. The window covering system of claim 15, wherein the catch has a configuration selected from the group consisting of a loop, an aperture in the bottom elongated member, a notch, a hook, a groove, an indentation, and a projection.

17. The window covering system of claim 15 further comprising a manual pull cord having a portion located exterior of the housing, and further comprising a receiving structure coupled to the motor, and the receiving structure frictionally receives a portion of the pull cord such that manual pulling of the pull cord from exterior of the housing corresponds to a rotational movement of the receiving structure, which in turn causes the motor to either wind or unwind, and which in turn causes at least one lifting cord to move and adjust a position of the bottom elongated member relative to the top elongated housing.

18. The window covering system of claim 17, wherein the pull cord has protuberances and the receiving structure comprises of a wheel, and wherein the receiving structure has corresponding surfaces to receive some the protuberances.

19. The window covering system of claim 18, wherein the protuberances are spheres disposed along a length of the pull cord, and the pull cord includes at least one selected from the group consisting of a beaded cord and ball-chain, and wherein the motor is comprised of an output drum and a storage drum, wherein the output drum is biased by the resilient member, and wherein the resilient member is a spring.

20. The window covering system of claim 19 further comprising a connecting cord coupled to the output drum, and wherein the wheel is attached to the output drum such that rotation of the wheel also causes the output drum to rotate and wind a portion of the connecting cord.

21. The window covering system of claim 20, wherein the connecting cord is coupled to the at least one lifting cord.

22. The window covering system of claim 19 further comprising a pulley set having at least one rotor in the channel, wherein the at least one rotor is in engaging contact with the at least one lifting cord.

23. The window covering system of claim 22, wherein the wheel is attached to one of the at least one rotor, such that rotation of the wheel also causes the rotor to rotate, which in turn causes the output drum to rotate.

24. The window covering system of claim 23, wherein the at least one rotor includes at least two rotors, wherein at least two rotors are coupled by meshing gear teeth, such that the turning of one rotor causes the other rotor to turn correspondingly, and wherein at least one rotor is attached to the connecting cord.

25. The window covering system of claim 21, wherein the hand tool has a elongated stem, and the distal end of the hand tool has a configuration selected from the group consisting of a loop, a notch, a hook, a groove, an indentation, a projection, a plurality of grasping fingers.

26. The window covering system of claim 22, wherein the pull cord has two ends joined together forming a continuous loop, and wherein the connecting cord is entrained by the storage drum and wound by the output drum, in a FIG. 8 configuration.

27. A method of marketing a cordless window covering system, comprising:
providing a window covering system having a housing which contains a motor;
wherein the window covering system further comprises a bottom elongated member coupled to a window cover;
wherein the window cover is attached to the housing, and the bottom elongated member is attached to the window cover;
wherein the motor is coupled to at least two lifting cords to suspend the bottom elongated member;
providing a secondary controlling mechanism to adjust a position of the bottom elongated member relative to the housing; and
providing an instruction to use the secondary controlling mechanism.

28. The method of claim 27 further providing a hand tool having a handle, a stem, and a distal end capable of manipulating the bottom elongated member, and providing an instruction describing that a position of the bottom elongated member can be adjusted by engaging the hand tool to the bottom elongated member, and wherein the motor is a spring-driven counter-balancing motor capable of substantially suspending a weight of the window cover and the bottom elongated member.

29. The method of claim 28, wherein the distal end of the hand tool has a configuration selected from the group consisting of a loop, a notch, a hook, a groove, an indentation, a projection, a plurality of grasping fingers.

30. The method of claim 29, wherein the instruction is a written instruction, and wherein the stem is sufficiently long so that a user may use the tool to reach the bottom elongated member when the system is installed in a window and when the bottom elongated member is at a position closest to the housing.

31. The method of claim 27, wherein the motor is coupled to a pull cord, and wherein the instruction provides that a user may manually pull on the pull cord to operate the window covering system.

32. The method of claim 27, wherein the instruction is a written instruction and the motor is an electric motor.

33. The method of claim 27, wherein the instruction is a written instruction and the motor is a spring-loaded counter-balancing motor capable of substantially counterbalancing a weight of the window cover and the bottom elongated member.
